(19) United States
(12) Patent Application Publication
(10) Pub. No.: US 2024/0019356 A1
(43) Pub. Date: Jan. 18, 2024

(54) AN OPTICAL ABSORBANCE SPECTROMETER, OPTICAL DEVICE AND METHOD OF OPTICAL ABSORBANCE SPECTROMETRY

(71) Applicant: ams-OSRAM AG, PREMSTAETTEN (AT)

(72) Inventors: Erik Jan LOUS, KE VELDHOVEN (NL); Remco VERDOOLD, AC GELDROP (NL)

(73) Assignee: ams-OSRAM AG, PREMSTAETTEN (AT)

(21) Appl. No.: 18/256,226

(22) PCT Filed: Dec. 3, 2021
(86) PCT No.: PCT/EP2021/084139

§ 371 Date: Jun. 7, 2023

(30) Foreign Application Priority Data
Dec. 9, 2020 (DE) 10 2020 132 726.9

(51) Int. Cl. G01N 21/03; G01N 21/31

(52) U.S. Cl. CPC G01N 21/031; G01N 21/3103; G01N 2021/0346; G01N 2201/0826

(57) ABSTRACT

An optical absorbance spectrometer includes a sample housing, a light source and a spectral sensor. The sample housing comprises at least two sample cells configured to hold a sample, respectively, and includes an optical waveguide which is configured to guide light from an input side, through the sample cells, to an output side. The light source is operable to emit broadband light and is connected to the input side to couple emitted light into the optical waveguide. The spectral sensor is connected to the output side and operable to receive light from the optical waveguide and to detect the intensity of the received light at multiple wavelengths.

### CROSS-REFERENCE TO RELATED APPLICATIONS

The present application is a national stage entry from International Application No. PCT/EP2021/084139, filed on Dec. 3, 2021, published as International Publication No. WO 2022/122577 A1 on Jun. 16, 2022, and claims priority to German Patent Application No. 10 2020 132 726.9, filed Dec. 9, 2020, the disclosures of all of which are hereby incorporated by reference in their entireties.

### FIELD OF DISCLOSURE

This disclosure relates to an optical absorbance spectrometer, an optical device and a method of optical absorbance spectrometry.

This patent application claims the priority of German patent application No. 102020132726.9, the disclosure content of which is hereby incorporated by reference.

### BACKGROUND

Absorption spectroscopy is routinely used in analytical chemistry for the quantitative determination of different analytes. Spectroscopic analysis is commonly carried out with the analytes placed in micro-cuvettes of given path lengths. A common optical absorbance spectrometer comprises a light source, a holder for the cuvette, a diffraction element to separate the different wavelengths of light, and a detector. Measuring absorbance spectra allows for determining various parameters, such as concentration by means of the Lambert Beer law. In common setups, however, multiple parameters of one or more analytes demand a corresponding number of single measurements. Alternatively, a corresponding number of light sources and/or detectors can be used in parallel. Thus, with a single light source multiple parameters can only be measured sequentially. Parallel measurement of multiple parameters requires multiple light sources and detectors. At the same time each measurement is restricted by the path length of a corresponding cell of the cuvette. For example, four different cholesterol parameters can be measured by taking four single modules, wherein each module includes one optical illumination source, a micro-cuvette and a spectral sensor.

It is an object of the present disclosure to provide an optical absorbance spectrometer, an optical device and a method of optical absorbance spectrometry which overcome the shortcomings of the art.

These objectives are achieved by the subject matter of the independent claims. Further developments and embodiments are described in the dependent claims.

It is to be understood that any feature described in relation to any one embodiment may be used alone, or in combination with other features described herein, and may be used in combination with one or more features of any other of the embodiments, or any combination of any other of the embodiments unless described as an alternative. Furthermore, equivalents and modifications not described below may also be employed without departing from the scope of the optical absorbance spectrometer, optical device and method of optical absorbance spectrometry which are defined in the accompanying claims.

### SUMMARY

The following relates to an improved concept in the field of optical absorbance spectrometry. The improved concept suggests an optical absorbance spectrometer comprising a sample housing with two or more sample cells. An optical waveguide guides light through the sample cells such that ultimately a single light source and a single spectral sensor may suffice to allow for spectrometry of multiple parameters. The optical waveguide may be implemented as a linear or circular structure, wherein the sample cells can be irradiated sequentially, e.g. by serial addition or by filling/emptying each sample cell. The optical waveguide may be implemented as a parallel structure, wherein the sample cells can be irradiated in parallel, e.g. using split beams of light. The proposed optical absorbance spectrometer can be accompanied with micro-fluidics which determines timing of filling/emptying cuvettes, for example. Absorption spectra can be calculated using combined or differential spectra. For example, absorbance spectra can be calculated on a dedicated ASIC or on an external host system.

The optical waveguide allows for different coupling of light paths and timing of microfluidics. This allows for cost effective solutions for multi-parameter applications. The number of light sources and/or spectral sensors can be reduced. There may be no moving parts, except microfluidics.

The necessary volumes per cuvette (e.g., 1 to 2 mm³) can be miniaturized, while still having optical path lengths of 1 to 25 mm or longer.

In at least one embodiment an optical absorbance spectrometer comprises a sample housing, a light source and a spectral sensor. The sample housing comprises at least two sample cells which are configured to hold a sample, respectively. Furthermore, the sample housing comprises an optical waveguide having an input side and an output side. The light source is connected to the input side and the spectral sensor is connected to the output side. The optical waveguide is configured to guide light from the output side, through the sample cells, to the output side.

In use, the light source is emitting a broadband light which is coupled into the optical waveguide. The light is guided through the sample cells between the input side and the output side by means of the optical waveguide. The light is then received from the optical waveguide by means of the spectral sensor which is operable to detect the intensity of the received light at multiple wavelengths.

The optical waveguide optically connects the sample cells with the light source and the spectral sensor. This way a beam of light emitted by the light source can be steered through several or all of the sample cells, in parallel or in series. Transmission spectra can be recorded depending on which sample is present in one or more of the sample cells. In fact, the optical absorbance spectrometer can be used with several measurement procedures, e.g. which determine timing of filling and/or emptying of sample cells. These measurement procedures allow to isolate individual spectra or combine spectra in order to derive multiple parameters, such as concentration of a specimen in a particular sample.

Furthermore, due to the optical waveguide a light source or a spectral sensor can be shared by one or more sample cells.

The sample housing comprises the sample cells which can be used as micro-cuvettes for volumes around 1 to 2 μl. Due to the optical waveguide, however, spectral transmission or absorbance can be measured in a way that the optical path length still can be in the order of 1 to 25 mm range. The number of sample cells (or micro-cuvettes) is only restricted by the application at hand. If, in the following, the description refers to four sample cells, this is only intended as an example but may be no means be considered a restriction of the proposed concept.

Some advantages of the proposed concept include that a multitude of sample cells (or micro-cuvettes) can be arranged in a way to measure and determine absorbance of each individually in a cost effective way with ultimately only one light source and only one spectral sensor. This allows to arrange the spectrometer as a disposable component with no moveable mechanical parts, where sample housing and/or detector systems (light source and/or sensor) are exchanged. One field of applications relates to bio-diagnostics for point-of-care devices. To measure e.g. the four cholesterol parameters in absorbance, one can simply take four times a single absorbance point of care, Abso PoC, module to do this. However, also other parameters can be combined measured. The application can not only be used in medical PoC, but also in environmental and veterinary diagnostics. Also use in general areas of chemistry and biology can be envisioned, as food quality etc.

The optical absorbance spectrometer allows for conduction absorption spectroscopy or spectrometry. For example, the spectral sensor detects the intensity of the received light at multiple wavelengths. The detection is the result of light transmission through one or more of the sample cells, e.g. filled with sample. The transmission is detected as a function of wavelength, which may be represented as a spectrum, e.g. a transmission, absorption or absorbance spectrum. Absorbance, or spectral absorbance, is the common logarithm of the ratio of incident to transmitted spectral radiant power through a material. Absorbance is a dimensionless measure and monotonically increases as a function of optical path length.

In at least one embodiment the optical absorbance spectrometer comprises a single light source. Ultimately, the optical waveguide can be arranged so that a single light source may suffice to conduct spectroscopic measurements of multiple parameters using the at least two, or more, sample cells.

In at least one embodiment the optical absorbance spectrometer comprises a single spectral sensor. Ultimately, the optical waveguide can be arranged so that a single spectral sensor may suffice to conduct spectroscopic measurements of multiple parameters using the at least two, or more, sample cells.

In at least one embodiment the optical absorbance spectrometer further comprises one or more reflectors which are configured to reflect light such that the light passes through the sample cells multiple times. The reflectors allow for extending the optical path length of a sample cell, e.g. to a range of 1 to 25 mm. This way optical attenuation of a sample containing an attenuating species can be increased. For example, this allows for measuring highly diluted samples or samples which would not show a detectable absorbance if a sample has no reflectors. In turn, the reflectors allow the sample cells to be reduced in size, which ultimately results in a compact design, e.g. for mobile applications, or a design which allows for high density of sample cells in a given space.

In at least one embodiment the light source is configured to provide a beam of emitted broadband light. The beam of light travels along the optical waveguide from the input side, through one or more of the sample cells, to the output side. Broadband light allows for excitation of a sample within a large spectral range, e.g. in vis, UV/vis and/or IR. These terms relate to visual (vis), ultraviolet (UV) and infrared (IR) range of the electromagnetic spectrum. However, if only a specific specimen is to be measured, then the spectral range of the light source may be restricted to a smaller range of excitation wavelengths, or even a single line. Possible light sources include light emitting diodes, laser diodes (such as VCSEL lasers), and other types of lasers, incandescent light sources or other light sources known in spectroscopy. However, the optical absorbance spectrometer may be used with light sources which lend themselves to integration in a semiconductor process, in order to achieve compact and cost-effective manufacture.

In at least one embodiment the light source and the reflectors are configured such that the beam of light crosses the sample cells multiple times as the beam of light travels along the sample cells. The beam may cross a given sample cell multiple time before entering another sample cells. In addition, or alternatively, the beam may travel from one sample cell to another before traveling the same sample cells another time. In both cases optical path length can be increased.

In at least one embodiment the optical waveguide is configured to split the beam of light into partial beams of light. Each partial beam of light travels through a dedicated one of the sample cells. Splitting into partial beams is possible by means of the optical waveguide. For example, there may be cases where more than a single light source or a single spectral sensor is needed. By splitting the beam, e.g. by means of dedicated sections of the optical waveguide, it is possible to receive or to direct a beam of light from the light sources or to the spectral sensors.

In at least one embodiment the beam of light travels through all of the sample cells. Instead of splitting the beam, there may be cases where the optical waveguide provides an optical path which optically connects the light source (or light sources) with the spectral sensor (or spectral sensors) such that the beam passes though all sample cells, either in parallel or in series.

In at least one embodiment the optical absorbance spectrometer further comprises a microfluidic system which is operable to fill and empty the sample cells with a sample substance. The microfluidic system may determine a timing of filling and emptying one or more of the sample cells. For example, a spectrum can be recorded after filling of one sample cell and leaving the remaining sample cells empty.

Different sample cells and liquids/gases can be measured by emptying the said filled sample cell first and fill the next sample cell or by leaving said sample cell filled and proceed with filling another sample cell. The microfluidics may determine the timing of cuvette fills and emptying. The fluidic control could be active with valves or passive (capillary) with microfluidic holding chambers. A default start condition may be to measure the empty sample cells first and the responses of each light source and/or spectral sensor. Each combination may be known and can be used for an absorbance calculation.

In at least one embodiment the optical absorbance spectrometer further comprises an integrated circuit which is operable to control operation of the light source, microfluidic system and/or the spectral sensor. Control may be triggered by the microfluidic system, e.g. by receiving a start signal from microfluidic system or by detecting operation of the microfluidic system, e.g. by means of optical, capacitive or any other means of detection.

Then, the integrated circuit initiates and conducts control of the light source and the spectral sensor to perform a measurement workflow. The integrated circuit may comprise electronic components to control operation of the light source, and/or spectral sensor, and/or the microfluidics system. The integrated circuit may comprise a microprocessor or ASIC to allow for operation control. The microprocessor or ASIC may be operable to conduct calculations on recorded spectra, e.g. taking a difference to obtain a difference spectrum, etc. Integration may be achieved for example using CMOS back-end technology or using packaging technology to form a system on a semiconductor chip. Furthermore, the optical absorbance spectrometer may be integrated together with a microfluidic cartridge in a package.

In at least one embodiment the sample cells have a volume of less than 10 μl. For example, the sample cells have volumes around 1 to 2 μl. In at least one embodiment the optical waveguide comprises a light pipe and/or an optical fiber structure. The light pipe may have reflecting inner surfaces, such as coated or metallized reflecting walls, to increase reflectivity and signal-to-noise ratio.

In at least one embodiment an optical device comprises an optical absorbance spectrometer according to one or more of the aspects discussed above. Furthermore, the optical device comprises a host system, wherein the host system comprises a mobile device, a disposable system, or a laboratory measuring device, a point-of-need system or any system which can transmit a measurement result to a mobile phone, PC, laptop, tablet or watch.

In at least one embodiment a method of optical absorbance spectrometry comprises the following steps. First, samples are provided in at least two sample cells of a sample housing. The sample housing comprises an optical waveguide. Then, a broadband light is guided from an input side of the optical waveguide, through the sample cells, to an output side of the optical waveguide. Finally, the intensity of the light travelling through the waveguide is detected at multiple wavelengths after the light has excited the samples in the sample cells.

In at least one embodiment the samples are provided in series or in parallel by filling and/or emptying the sample cells.

Absorbance spectra are calculated from the detected intensity of the light at multiple wavelengths.

Further implementations of the method are readily derived from the various implementations and embodiments of the optical absorbance spectrometer and optical device, and vice versa.

The following description of figures of example embodiments may further illustrate and explain aspects of the improved concept. Components and parts with the same structure and the same effect, respectively, appear with equivalent reference symbols. Insofar as components and parts correspond to one another in terms of their function in different figures, the description thereof is not necessarily repeated for each of the following figures.

### BRIEF DESCRIPTION OF THE DRAWINGS

In the Figures:

FIG. 1 shows an example embodiment of an optical absorbance spectrometer,

FIG. 2 shows another example embodiment of an optical absorbance spectrometer,

FIG. 3 shows another example embodiment of an optical absorbance spectrometer

FIG. 4 shows another example embodiment of an optical absorbance spectrometer, and

FIG. 5 shows another example embodiment of an optical absorbance spectrometer.

### DETAILED DESCRIPTION

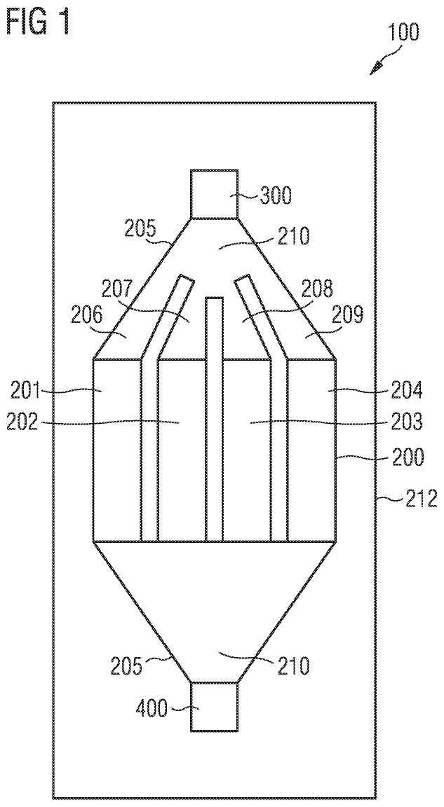

FIG. 1 shows an example embodiment of an optical absorbance spectrometer. The optical absorbance spectrometer 100 comprises a sample housing 200, a light source 300 and a spectral sensor 400.

The light source 300 emits a broadband light, e.g. in a range from around 400 nm to around 850 nm (vis). The emission may also extend into the infrared, IR, or near infrared, NIR, e.g. 780 to 1400 nm or into the ultraviolet, UV, with wavelengths smaller than 400 nm. The light source can be implemented as a broadband light emitting diode or laser diode, for example. Other light sources may be used, such as an incandescent light or any other light source suitable for spectroscopy, and may for example emit light over a wavelength range of at least 300 nm (or at least 400 nm).

The spectral sensor 400 detects the intensity of received light at multiple wavelengths. For example, the spectral sensor comprises an array of photodiodes, or other types of light sensitive components. Each photodiode of the array is complemented with a spectral filter of a defined passband. The spectral filters allow only light at particular wavelength or wavelength range to pass onto its corresponding photodiode. For example, each spectral filter has a different passband, which may only have a small or no spectral overlap with any other spectral filter in the array. This allows for high spectral resolution and there is no need of a dispersive element such as a grating or prism to achieve spectral separation. In another example, a same spectral filter can be provided for pairs or groups of photodiodes, so there are a number of different wavelengths being sensed by the array. This allows for averaging of the signal obtained for each detected wavelength and provides an improved signal to noise ratio.

The sample housing 200 comprises at least two sample cells. In this embodiment the sample housing comprises four sample cells 201, 202, 203, 204, as an example. The sample cells are configured to hold a sample, e.g. a liquid or gas to be measured. The sample housing further comprises an optical waveguide 205, such as a light pipe and/or an optical fiber structure. The optical waveguide comprises an input side 210 and an output side 211. The input side is optically connected to the light source 300 and the output side is optically connected to the spectral sensor 400. The term “optically connected” denotes that light can either be coupled into the optical waveguide (via the input side) or be coupled out of the optical waveguide (via the output side). The light source and spectral sensor may simply be placed in front of input and output side to couple light into and out of the optical waveguide. However, coupling efficiency may be increased using additional coupling optics (e.g., lenses, mirrors, prisms, etc., not shown).

The light source and the spectral sensor may be provided on a common semiconductor substrate, or may be provided on different semiconductor substrates. The light source and the spectral sensor may be secured to the input and output side, or to coupling optics if present, using an optically transparent adhesive.

In this embodiment, the optical waveguide 205 the input side 210 is segmented into optically separated sections. In this embodiment the optical waveguide comprises four sections 206, 207, 208, 209, as an example. The term “optically separated” denotes that light can travel along a section, while not effecting another section of the optical waveguide, e.g. by optical crosstalk. The optical waveguide may be surrounded by black mold to increase optical separation. A beam of light entering the optical wave guide via its input side is split into partial beams of light. In this example a beam of light is split into four partial beams of light.

The optically separated sections spread out and each section is optically connected to a respective sample cell. In this embodiment, as an example, a first section 206 is optically connected to a first sample cell 201. A second section 207 is optically connected to a second sample cell 202. A third section 207 is optically connected to a third sample cell 203. A fourth section 208 is optically connected to a fourth sample cell 204.

The output side 211 is optically connected to the sample cells. In this embodiment, as an example, the output side 211 is not further segmented and, thus, is configured to receive any beam of light which has passed through any of the sample cells. However, output side 211 can be segmented into optically separated sections, similar to those of the input side. This way dedicated sections could guide a beam passed through a corresponding sample cell towards the spectral sensor, for example.

In use, one or more of the sample cells hold a sample. A possible sequence of a method of optical absorbance spectrometry will be discussed in more detail below. Basically, the light source 300 provides a beam of emitted broadband light, which is coupled into the optical waveguide 205 via the input side 210. The beam of light is split into partial beams by the sections 206, 207, 208, and 209 at the input side of the optical waveguide. Each partial beam of light travels through a dedicated one of the sample cells 201, 202, 203, and 204. After passing the sample cells, the partial beams are collected by means of the output side 211 and guided out of the optical waveguide. The beams are coupled out of the optical waveguide and light is eventually received by the spectral sensor 400. The intensity of received light, or of the received beam of light, is detected at multiple wavelengths.

The optical absorbance spectrometer comprises a single light source and a single spectral sensor. Yet the spectrometer allows for measuring multiple samples and derive multiple related parameters from the recorded spectra, in parallel or in series. For example, in order to measure the four cholesterol parameters in absorbance, one can simply take four times a single sample cells to do this. In prior art single-cuvette modules this takes one optical illumination source and a spectral sensor but taken four times. This multiplies the bill of material cost by a factor of four. This can be a serious drawback in cost and may not be accepted in large scale testing. The optical absorbance spectrometer of this embodiment uses just a single light source for optical illumination and a single spectral sensor for detection of transmission spectra. The sample cells are effectively placed in parallel and can be filled and emptied after each other, e.g. controlled by microfluidics. By taking difference spectra, the transmission spectra and absorbance per sample cell (i.e. per channel) can be calculated. The intensity of light incident at the spectral sensor depends upon the intensity of light emitted by the light source and on the absorbance of the sample. A different intensity of light may be seen at different wavelengths, due to the sample having different absorbance at different wavelengths.

The implementation of the optical absorbance spectrometer discussed with respect to FIG. 1 allows to establish the following workflow of a method of optical absorbance spectrometry. Due to the discussed design of the sample housing it can be assumed that a distribution of light over the channels is known.

### Workflow 1

1. Empty the sample cells, if not empty already.
2. Measure a light transmission of all empty sample cells
3. Store respective transmission spectra as reference spectrum.
4. Fill first sample cell with a first sample.
5. Measure light transmission of all sample cells.
6. Store light transmission as first transmission spectrum.
7. Calculate absorbance of first sample cell using the first transmission spectrum and the reference spectrum.
8. Fill second sample cell with a second sample.
9. Measure light transmission of all sample cells.
10. Store light transmission as second transmission spectrum.
11. Calculate absorbance of second sample cell using the first and second transmission spectra and the reference spectrum.
12. Fill third sample cell with a third sample.
13. Measure light transmission of all sample cells.
14. Store light transmission as third transmission spectrum.
15. Calculate absorbance of third sample cell using the first, second and third transmission spectra and the reference spectrum.
16. Fill fourth sample cell with a fourth sample.
17. Measure light transmission of all sample cells.
18. Store light transmission as fourth transmission spectrum.
19. Calculate absorbance of fourth sample cell using the first, second, third and fourth transmission spectra and the reference spectrum.
20. Done.

Workflow 1 relies on subsequent addition of sample to the sample cells. Thus, the measured light transmission will subsequently build up with contributions of the respective samples. Thus, the first transmission spectrum will show absorbance only from the first sample. The second transmission spectrum, however, will show absorbance from the first and second sample. The absorbance for the second sample can be calculated by taking the difference from the first and second transmission spectra. This concept can be generalized for all sample cells and samples in the sample housing. In fact, any number of sample cells equal or greater than two can be implemented and corresponding absorbance can be calculated based on workflow 1.

The optical absorbance spectrometer, however, is not limited to one workflow. For example, the following workflow 2 can be used with the same spectrometer as well.

### Workflow 2

1. Empty the sample cells, if not empty already.
2. Measure a light transmission of all empty sample cells.
3. Store respective transmission spectra as reference spectrum.
4. Fill first sample cell with a first sample.
5. Measure light transmission of all sample cells.
6. Store light transmission as first transmission spectrum.
7. Calculate absorbance of first sample cell using the first transmission spectrum and the reference spectrum.
8. Empty first sample cell.
9. Fill second sample cell with a second sample.
10. Measure light transmission of all sample cells.
11. Store light transmission as second transmission spectrum.
12. Calculate absorbance of second sample cell using the second transmission spectrum and the reference spectrum.
13. Empty second sample cell.
14. Fill third sample cell with a third sample.
15. Measure light transmission of all sample cells.
16. Store light transmission as third transmission spectrum.
17. Calculate absorbance of third sample cell using the third transmission spectrum and the reference spectrum.
18. Empty third sample cell.
19. Fill fourth sample cell with a fourth sample.
20. Measure light transmission of all sample cells.
21. Store light transmission as fourth transmission spectrum.
22. Calculate absorbance of fourth sample cell using the fourth transmission spectrum and the reference spectrum.
23. Empty fourth sample cell (not needed for disposable)
24. Done

Workflow 2 relies on subsequent addition of sample to the sample cells. However, after calculating absorbance of a given sample the sample cell is emptied. Thus the measured light transmission does not subsequently build up with contributions of with the respective samples. Rather the light transmission of one sample at a time is used to calculate absorbance. This concept can be generalized for all sample cells and samples in the sample housing. In fact, any number of sample cells equal or greater than two can be implemented and corresponding absorbance can be calculated based on workflow 2.

The term “calculate absorbance of Zth sample cell using the Xth, Yth and Zth transmission spectra” is considered a placeholder for various mathematical operations. For example, the calculation may involve a difference of several spectra or of intermediate spectra already calculated in a previous step. The reference spectrum may serve as a reference but may also be left out.

The workflows above can be assisted with a microfluidic system which fills and empties the sample cells with sample substance. These may be part of the spectrometer or an optical device acting as a host system for the spectrometer, e.g. a mobile device or laboratory measuring device, etc. The optical absorbance spectrometer or the sample housing may be disposable components, which allow for cost effective spectroscopy as the sample housing and/or the light source and spectral sensor can be made at a large scale.

Furthermore, the optical absorbance spectrometer may be implemented as an integrated circuit which comprises electronic components to control operation of the light source, and/or spectral sensor, or even the microfluidics system or can sense operation of the microfluidic system by any means (e.g. optical, capacitive detection of liquid/gas flow) and trigger its operation, i.e. initiate and conduct a measurement workflow. The integrated circuit may comprise a microprocessor or ASIC to allow for operation control. The fluidic control may be active with valves or passive (capillary) with microfluidic holding chambers. A default start condition could be to measure the empty sample cells first and the responses of each optical illuminator and/or spectral sensor. Each combination could be saved and used for the absorbance calculation. Integration may be achieved for example using CMOS back-end technology or using packaging technology to form a system on a semiconductor chip. For example, the different optical waveguide and cuvette systems, considered as channels (e.g. 4 channels for cholesterol) are optically isolated by black mold.

At least parts of the optical absorbance spectrometer may be implemented as a photonic integrated circuit. For example, coupling of light into and out of the optical waveguide may be established by photonic components such as grating couplers. The optical waveguide may be implemented as a waveguide grating, for example. This way the optical absorbance spectrometer can be further simplified in design complexity, compact form factor and cost may be reduced further. This may especially lend these system for disposable use in large scale multi-parameter testing.

Furthermore, the sample housing may be implemented based on a carrier 212. The optical waveguide may be arranged on said carrier or be an integral part of the carrier, for example. Thus, the sample housing can be considered being part of, or comprising, the optical waveguide. In other words, the sample cells may also act as input or output side of the optical waveguide with one or more light sources and/or one or more spectral sensors connected to the sample cells. The housing prevents optical crosstalk between the optical channels.

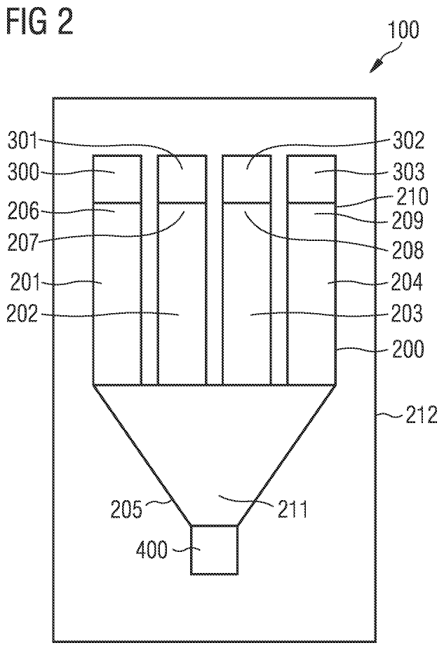

FIG. 2 shows another example embodiment of an optical absorbance spectrometer. The optical absorbance spectrometer 100 comprises a sample housing 200, light sources 300, 301, 302, 303 and a spectral sensor 400. The embodiment of FIG. 2 is a design alternative and differs from the one of FIG. 1 in the implementation of the input side 210.

The input side of the optical waveguide 205 comprises a number of sections, which corresponds to the number of sample cells. In this example, the optical waveguide comprises four sections 206, 207, 208, 209, which optically connect four light sources 300, 301, 302, and 303 to four sample cells 201, 202, 203, and 204. These sections can be separate from the sample cells, e.g. configured as an intermediate means to optically connect the light sources to the sample cells. They may also be implemented by coupling optics or by an optically transparent adhesive, for example. However, the sample cells can be directly connected to the light sources and, thus, may act as the input side of the optical waveguide.

The alternative design of FIG. 2 relies on four light sources, one for each section or sample cell, instead of a single light source as for the implementation in FIG. 1.

In use, one or more of the sample cells hold a sample. A possible sequence of a method of optical absorbance spectrometry will be discussed in more detail below.

Basically, the light sources 300, 301, 302, and 303 each provide a beam of emitted broadband light, which are coupled into the sections of the optical waveguide 205. The beams of light are guided by the sections and travel through a dedicated one of the sample cells in optically isolated mold with respect to each other. After passing a sample cell, the beams are collected by means of the output side 211 and guided out of the optical waveguide. The beams are coupled out of the optical waveguide and light is eventually received by the spectral sensor 400. The intensity of received light, or the received beam of light, is detected at multiple wavelengths.

The implementation of the optical absorbance spectrometer discussed with respect to FIG. 2 allows to establish the following workflow of a method of optical absorbance spectrometry.

### Workflow 3

1. With all sample cells empty (or filled with a known solvent, e.g. the solvent used to prepare the sample to be measured) measure first the transmitted light intensity of the empty (or so prepared) sample cells.
2. Fill first sample cell with a first sample.
3. Measure light transmission of the first sample cell with first light source on and the other light sources off.
4. Store the measured transmission, e.g. as first transmission spectrum.
5. Fill second sample cell with a second sample.
6. Measure light transmission of the second sample cell with the second light on and the other light sources off.
7. Store the measured transmission, e.g. as second transmission spectrum.
8. Fill third sample cell with a third sample.
9. Measure light transmission of the third sample cell with the third light source on and the other light sources off.
10. Store the measured transmission, e.g. as third transmission spectrum.
11. Fill fourth sample cell with a fourth sample.
12. Measure light transmission of the fourth sample cell with the fourth light source on and the other light sources off.
13. Store the measured transmission, e.g. as fourth transmission spectrum.
14. Calculate absorbance from the stored measured transmission.
15. Done.

In an alternative to workflow 3, all the sample cells may be filled together. Then steps 3 and 4, 6 and 7, 9 and 10, and 12 and 13 are executed. Finally, absorbance is calculated from the stored measured transmission (or transmission spectra). The alternative may also be combined with steps 1 to 15 of workflow 3.

There are a few alternatives possible regarding the order to do things: e.g. by measuring the empty sample just before filling it and measure again.

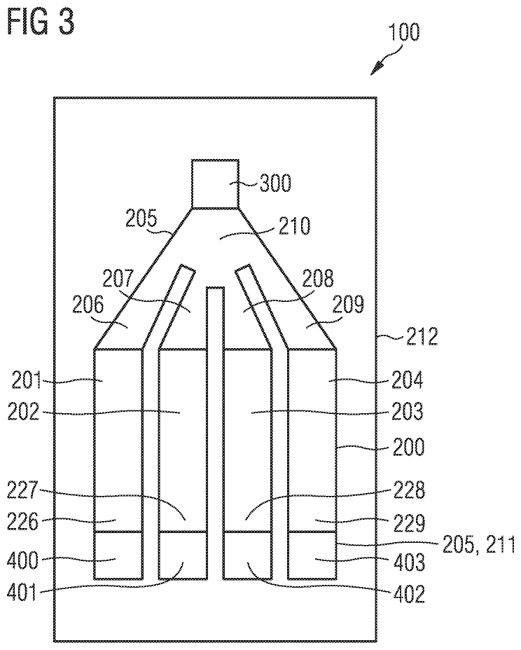

FIG. 3 shows another example embodiment of an optical absorbance spectrometer. The optical absorbance spectrometer 100 comprises a sample housing 200, a light source 300 and spectral sensors 400, 401, 402, 403. The embodiment of FIG. 3 is another design alternative and differs from the one of FIG. 1 in the implementation of the output side 211.

The input side is implemented in the same way as in FIG. 1. Thus, the input side of the optical waveguide 205 comprises a number of sections, which correspond to the number of sample cells. In this example, the optical waveguide comprises four sections 206, 207, 208, 209, which optically connect the light source 300 to the sample cells 201, 202, 203, and 204.

The output side of the optical waveguide 205 comprises a number of sections, which correspond to the sample cells. In this example, there are four sections 226, 227, 228, 229, which optically connect four sample cells 201, 202, 203, and 204 to four spectral sensors 400, 401, 402, and 403. These sections can be separate from the sample cells, e.g. configured as an intermediate means to optically connect the spectral sensors to the sample cells. These may be achieved by a coupling optic or by an optically transparent adhesive, for example. However, the sample cells can be directly connected to the spectral sensors and, thus, may act as the output side of the optical waveguide.

The alternative design of FIG. 3 relies on four spectral sensors, one for each section or sample cell, instead of a single spectral sensor as in FIG. 1.

In use, one or more of the sample cells hold a sample. A possible sequence of a method of optical absorbance spectrometry will be discussed in more detail below.

Basically, the light source 300 provides a beam of emitted broadband light, which is coupled into the sections of the optical waveguide 205. The beam of light is split into partial beams which are guided by the sections and travel through a dedicated one of the sample cells. After passing a sample cell, the beams are guided, optically isolated from each other, out of the optical waveguide and eventually are received by the spectral sensors 400, 401, 402, and 403. The intensity of received light, or the received beam of light, is detected at multiple wavelengths.

The implementation of the optical absorbance spectrometer discussed with respect to FIG. 3 allows to establish the following workflow of a method of optical absorbance spectrometry.

### Workflow 4

1. Empty all sample cells (or fill with a known solvent, e.g. the solvent used to prepare the sample to be measured).
2. With all sample cells so prepared, measure a set of transmission spectra using the spectral sensors. Store the set as reference transmission.
3. Measure light transmission of the first sample cell with the first spectral sensor on and the other spectral sensors off. Store measured transmission as first reference transmission spectrum.
4. Measure light transmission second sample cell with second spectral sensor on and the other spectral sensors off. Store measured transmission as second reference transmission spectrum.
5. Measure light transmission third sample cell with third spectral sensor on and the other spectral sensors off. Store measured transmission as third reference transmission spectrum.
6. Measure light transmission fourth sample cell with fourth spectral sensor on and the other spectral sensors off. Store measured transmission as fourth reference transmission spectrum.
7. Fill all the sample cells with samples.
8. Measure light transmission of the first sample cell with the first spectral sensor on and the other spectral sensors off. Store measured transmission as first transmission spectrum.
9. Measure light transmission second sample cell with second spectral sensor on and the other spectral sensors off. Store measured transmission as second transmission spectrum.
10. Measure light transmission third sample cell with third spectral sensor on and the other spectral sensors off. Store measured transmission as third transmission spectrum.
11. Measure light transmission fourth sample cell with fourth spectral sensor on and the other spectral sensors off. Store measured transmission as fourth transmission spectrum.
12. Calculate absorbance from the stored transmission spectra using the stored reference transmission spectra as references, respectively.
13. Done.

The spectral sensors do not need to be “off”, i.e. not actively measuring. For example, if the channels are well optically isolated than the spectral sensor may conduct measurements simultaneously. Furthermore, there are a few alternatives possible in the order to conduct the procedural steps, e.g. by measuring an empty sample cell just before filling it and measure again.

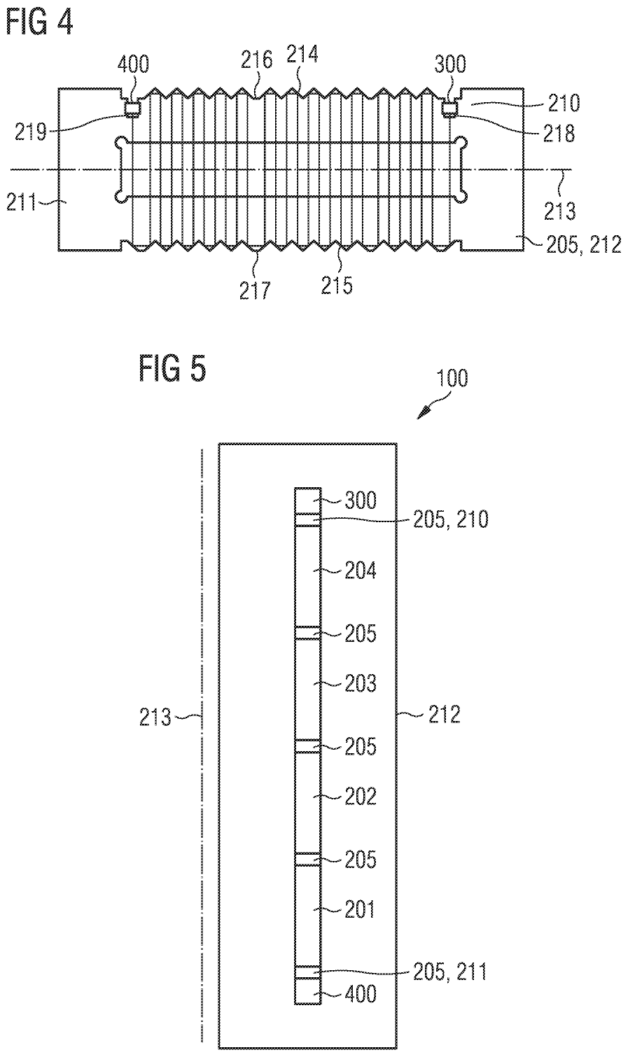

FIG. 4 shows another example embodiment of an optical absorbance spectrometer. The optical absorbance spectrometer 100 comprises a sample housing 200, a light source 300 and a spectral sensor 400. This design can be considered an alternative of FIG. 1 using a single light source and a single spectral sensor.

The sample housing 200 comprises a carrier which comprises the optical waveguide 205. The carrier is made of an optically transparent material and may be optically opaque at least at some outer surfaces to prevent any optical crosstalk into the carrier. The sample cells are arranged in the carrier along a main axis 213.

The input side 210 comprises a first mounting site 218 to attach the light source 300. The first mounting site is configured to direct and couple a beam of light emitted by the light source into the optical waveguide (or carrier) and direct said beam towards a first sample cell.

The carrier further comprises a plurality of reflectors 214, 215 which are arranged along a first and second surface 216, 217. The first and second surface are essentially parallel to the main axis 213 and opposite to each other. The reflectors 214, 215 are configured to reflect light such that the light passes through the sample cells multiple times.

The output side 211 comprises a second mounting site 219 to attach the spectral sensor 400. The second mounting site is configured to couple a beam of light out of the optical waveguide (or carrier), e.g. received from a last reflector, and direct said beam towards the spectral sensor.

The reflectors can be implemented in a variety of ways. The drawing depicts the reflectors as zigzags, for example. This way the reflectors function as “mirrors” to steer the beam through the optical waveguide. The reflectors may be coated with a reflective material in order to increase reflectivity. Furthermore, a material of the sensor housing and/or the optical waveguide, e.g. including the reflectors, considered as “inner” medium, may have a higher refractive index than the “outer” medium (which under normal operation conditions is air). The reflectors are arranged to include an angle with respect to each other that yields total reflection. In some embodiments the reflectors may, apart from beam steering, have additional optical properties. For example, the reflectors may have a shape which forms the beam while travelling through the optical waveguide. This way a beam divergence may be reduced or the beam be collimated. For example, the reflectors are concave or parabolic. By way of the reflectors the beam is reflected within the optical waveguide for multiple times. This design is considered a circular design.

In use, one or more of the sample cells hold a sample. A possible sequence of a method of optical absorbance spectrometry will be discussed in more detail below. Basically, the light source 300 provides a beam of emitted broadband light, which is coupled into the optical waveguide 205 via the input side 210. The beam of light is directed into the optical waveguide and through a first sample cell. In fact, the beam is not split into partial beams by sections as in other embodiments. After passing the first sample cell, the beam is directed to a first reflector. The beam is reflected by said first reflector and travels again through the first sample cell towards a second reflector, where the beam is reflected again. This way the beam is reflected multiple times inside the first sample cell. A last reflector associated with the first sample cell then reflects and directs the beam to travel though the second sample cell, where the beam is reflected through the cell volume multiple times again. This applies for all sample cells and their corresponding reflectors until finally the beam reaches a last reflector, which is configured to direct said beam towards spectral sensor located at the second mounting site 219. The beam is collected by means of the output side 211 and guided out of the optical waveguide, i.e. the beam is coupled out of the optical waveguide and light is eventually received by the spectral sensor 400. The intensity of received light, or the received beam of light, is detected at multiple wavelengths.

FIG. 5 shows another example embodiment of an optical absorbance spectrometer. The optical absorbance spectrometer 100 comprises a sample housing 200, a light source 300 and a spectral sensor 400. This design can be considered an alternative of FIG. 1 using a single light source and a single spectral sensor.

The sample cells are arranged along a main axis 213 so as to form a strip of sample cells. This design can be considered linear. The optical waveguide is arranged along the main axis too. The input side 210 is optically connected to the light source 300. The output side 211 is optically connected to the spectral sensor 400. The sample cells are optically connected to each other by way of the optical waveguide, i.e. by way of intermediate sections. This way there is a direct optical path (or linear path) which connects the light source, input side, sample cells, output side and spectral sensor.

Instead of the sample cells being arranged in a linear fashion they can also be rolled, or folded and beams are directed through the cells with help of reflectors. The optical waveguide can also be a hollow fiber, or a hollow light pipe, surrounded by reflectors. In general, the sample cells (or cuvettes) can be in one plane, but also in different planes, e.g. constructed above each other. Hence the folded hollow pipe traverses several layers, for example.

In use, one or more of the sample cells hold a sample. A possible sequence of a method of optical absorbance spectrometry will be discussed in more detail below. Basically, the light source 300 provides a beam of emitted broadband light, which is coupled into the optical waveguide 205 via the input side 210. The beam of light passes the sample cells and is collected by means of the output side 211 and guided out of the optical waveguide. The beam are coupled out of the optical waveguide and light is eventually received by the spectral sensor 400. The intensity of received light, or of the received beam of light, is detected at multiple wavelengths. This implementation is an alternative to those discussed with respect to FIGS. 1 and 4 and, too, relies on just a single light source and a single spectral sensor while enabling measuring multiple sample cells in parallel or in series.

The implementations of the optical absorbance spectrometer discussed with respect to FIG. 4 or 5 allow to establish the following workflow of a method of optical absorbance spectrometry.

### Workflow 5

1. Measure light transmission of all sample cells, empty (or filled with a known solvent, e.g. the solvent used to prepare the sample to be measured).
2. Fill first sample cell with first sample.
3. Measure light transmission of all sample cells.
4. Store the measured transmission, e.g. as first transmission spectrum.
5. Calculate absorbance of first sample using the stored transmission spectrum.
6. Fill second sample cell with sample.
7. Measure light transmission of all sample cells.
8. Store the measured transmission, e.g. as second transmission spectrum.
9. Calculate absorbance of first sample using the stored transmission spectra.
10. Fill third sample cell with sample.
11. Measure light transmission of all sample cells.
12. Store the measured transmission, e.g. as third transmission spectrum.
13. Calculate absorbance of first sample using the stored transmission spectra.
14. Fill fourth sample cell with sample.
15.Measure light transmission of all sample cells.
16. Store the measured transmission, e.g. as fourth transmission spectrum.
17. Calculate absorbance of first sample using the stored transmission spectra.
18. Done

In this workflow sample is added to the sample cells as the procedure evolves. Thus, the contributions of the samples add. For example, in step 7 the measured light transmission of all sample cells has contributions of the first and second sample cell, and, consequently, so does the stored measured transmission, e.g. second transmission spectrum. In order to calculate the absorbance the contributions may be isolated, e.g. by taking a difference based on the first and second transmission spectra. This idea can be generalized to the other sample cells accordingly. The resulting spectra may also be corrected for a reference spectrum based on all sample cells being empty.

An alternative workflow may include the following steps (note: the order of filling is free to choose):

Workflow 6
1. Measure light transmission of all sample cells, empty (or filled with a known solvent, e.g. the solvent used to prepare the sample to be measured).
2. Fill first sample cell with first sample.
3. Measure light transmission of all sample cells.
4. Store the measured transmission, e.g. as first transmission spectrum.
5. Calculate absorbance of first sample using the stored transmission spectrum.
6. Empty first sample cell.
7. Fill second sample cell with sample.
8. Measure light transmission of all sample cells.
9. Store the measured transmission, e.g. as second transmission spectrum.
10. Calculate absorbance of first sample using the stored transmission spectrum.
11. Empty second sample cell.
12. Fill third sample cell with sample.
13. Measure light transmission of all sample cells.
14. Store the measured transmission, e.g. as third transmission spectrum.
15. Calculate absorbance of first sample using the stored transmission spectrum.
16. Empty third sample cell.
17. Fill fourth sample cell with sample.
18. Measure light transmission of all sample cells.
19. Store the measured transmission, e.g. as fourth transmission spectrum.
20. Calculate absorbance of first sample using the stored transmission spectrum.
21. Empty fourth sample cell (not needed if disposable).
22. Done

This alternative workflow elevates the need of taking difference spectra. Due to intermediate emptying the contributions of samples do not add and the recorded transmission spectra are only indicative of the sample measured at the time.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims. The following aspects may indicate examples of possible variations or modifications of the embodiments discussed with respect to the figures.

For example, the volume of the sample cells may essentially be the same for all sample cells. The term “sample cell” in the above is intended to mean a volume that is suitable for holding a sample in use, e.g. a liquid or gas.

One or more of the light sources may be fixed at a particular wavelength, and the spectral sensor may detect photons at any wavelength. This may be used for example to detect for a particular known molecule which absorbs at a particular wavelength. The spectral sensor may for example be a single photon avalanche photodiode.

One or more of the light sources may be tuneable to desired wavelengths (e.g. may be a tuneable LED or solid state laser, tuneable VCLSEL laser), and the spectral sensor(s) may detect photons at any wavelength. The spectral sensor(s) may for example be a single photon avalanche photodiode.

The beam of light provided by the light source(s) may be continuous. The beam of light, however, may be modulated, e.g. using an acousto-optic modulator or by modulating a current provided to the light source(s). Modulation of the beam of light may improve a signal to noise ratio provided by the optical absorbance spectrometer, e.g. via phase locked detection.

An optical absorbance spectrometer according to the proposed concept can be used for a variety of applications, including analytical chemistry or sensing of medical samples, e.g. samples of fluid from a body of a person or animal. Other applications relate environmental sensing, e.g. river water, pond water, sea water, or drinking water, or sampling in food or beverage production. Another application relates to home measurements, such as water in a swimming pool or water quality in general.

The proposed optical absorbance spectrometer may operate at a sufficiently low power to be powered using a battery or batteries (e.g. conventional batteries). Embodiments of the absorbance spectrometer may be sufficiently small that they can be carried by a user. Embodiments of the optical absorbance spectrometer may be sufficiently small that they can be worn by a user (e.g. on a wrist-strap).

Embodiments of the absorbance spectrometer may be disposable, e.g. including the light source(s) and/or the spectral sensor(s). However, in some embodiments only the sample housing may be disposable. Where this is the case, the light source(s) and/or spectral sensor(s) may be provided as dedicated modules, e.g. as a source and sensor housing, which can be mounted to the sample housing. This may ensure that the light source and sensor are aligned with the sample housing.

In some instances some purification of separation steps may be performed on the sample before it can be used. Where this is the case the amount of usable sample may be between one fifth and one tenth of the sample which is obtained. Embodiments of the invention advantageously allow a smaller initial sample to be obtained in such circumstances.

The filters that are provided on the spectral sensor(s) may be configured to detect light at particular desired wavelengths (e.g. wavelengths which are known to be absorbed by molecules of interest). The example of a 4×4 array of photodiodes discussed should be considered only an example. The spectral sensor may have another arrangement, e.g. may have a 4 or more photodiodes, 16 or more photodiodes, e.g. 64 or more photodiodes. In general, the sensor may have a plurality of photodiodes or any other type of light sensor. The photodiodes, or light sensors, may be configured to detect light at different wavelengths (e.g. by providing filters over the photodiodes or light sensors).

In above described embodiments, light output from the light source may be converted into a beam using an aperture or coupling optics (not shown). This is a low cost way of providing the beam of light. However, any other suitable beam forming element, such as a lens, slit or pinhole, may be used.

The optical absorbance spectrometer may comprise a processor, e.g. a microprocessor, and a memory. The memory may be configured to store output values received from the spectral sensor. The processor may be configured to analyze the stored output values and to identify peaks in transmission which indicates the presence of a molecule of interest.

The workflows may be complemented with a calibration of the optical absorbance spectrometer. For example, light may be emitted from the light source and output values from the spectral sensor are stored, e.g. with a known calibration substance in the sample cells. After this the sample may be introduced and the absorbance spectrometry measurement according to one of the workflows discussed above performed, taking into account the output values obtained during calibration.

An alternative calibration may be used if the sample housing is removable from other parts of the optical absorbance spectrometer. A sample housing holding a reference solution such as a buffer solution may be used to the obtain output values. That sample housing may then be removed and replaced with a sample housing holding a sample to be analyzed. Again, the absorbance spectrometry measurement may take into account the output values received when reference solution was in the sample housing.

The sample housing may be referred to as a cuvette (although it has a volume which is smaller than a conventional cuvette.

1. An optical absorbance spectrometer comprising a sample housing, one or more reflectors, a light source and a spectral sensor, wherein:
the sample housing comprises at least two sample cells configured to hold a sample, respectively, and comprises an optical waveguide which is configured to guide light from an input side, through the sample cells, to an output side,
the light source is operable to emit broadband light and is connected to the input side to couple emitted light into the optical waveguide, and
the spectral sensor is connected to the output side and operable to receive light from the optical waveguide and to detect the intensity of the received light at multiple wavelengths,
the one or more reflectors are configured to reflect light such that the light passes through the sample cells multiple times, and
the light source and the reflectors are configured such that a beam of light crosses the sample cells multiple times as the beam of light travels along the sample cells.

2. The optical absorbance spectrometer according to claim 1 comprising a single light source.

3. The optical absorbance spectrometer according to claim 1, comprising a single spectral sensor.

4. (canceled)

5. The optical absorbance spectrometer according to claim 1, wherein
the light source is configured to provide a beam of emitted broadband light, and
the beam of light travels along the optical waveguide from the input side, through one or more of the sample cells, to the output side.

6. (canceled)

7. The optical absorbance spectrometer according to claim 1, wherein:
the optical waveguide is configured to split the beam of light into partial beams of light, and
each partial beam of light travels through a dedicated one of the sample cells.

8. The optical absorbance spectrometer according to claim 1, wherein the beam of light travels through all of the sample cells.

9. The optical absorbance spectrometer according to claim 1, further comprising a microfluidics system operable to fill and empty the sample cells with a sample substance.

10. The optical absorbance spectrometer according to claim 9 further comprising an integrated circuit which is operable to control operation of the light source, microfluidics system, and/or spectral sensor, and/or control is triggered by the microfluidic system.

11. The optical absorbance spectrometer according to one of claims claims 1, wherein the sample cells have a volume of less than 10 μl.

12. The optical absorbance spectrometer according to claim 1, wherein the optical waveguide comprises a light pipe and/or an optical fiber structure.

13. An optical device comprising:
an optical absorbance spectrometer according to claims 1,
a host system, wherein the host system comprises a mobile device, laboratory measuring device, a disposable system, a point-of-need system, or a system operable to transmit measurement data to a mobile phone or PC or laptop or tablet or watch.

14. A method of optical absorbance spectrometry, comprising:
providing samples in at least two sample cells of a sample housing, wherein the sample housing comprises an optical waveguide,
guiding of broadband light from an input side of the optical waveguide, through the sample cells, to an output side of the optical waveguide and
detecting the intensity of the light at multiple wavelengths after the light has excited the samples in the sample cells.

15. The method according to claim 14, wherein:
the samples are provided in series or in parallel by filling and/or emptying the sample cells, and
absorbance spectra are calculated from the detected intensity of the light at multiple wavelengths, in particular calculated from transmission spectra.
